(19) United States
(12) Patent Application Publication
(10) Pub. No.: US 2024/0214128 A1
(43) Pub. Date: Jun. 27, 2024

(54) INDICATION OF RETRANSMISSION FOR UPLINK IN NTN SYSTEMS

(71) Applicant: Nokia Technologies Oy, Espoo (FI)

(72) Inventors: Pingping WEN, Shanghai (CN); Ping YUAN, Beijing (CN)

(21) Appl. No.: 18/555,760

(22) PCT Filed: May 18, 2021
(86) PCT No.: PCT/CN2021/094456

§ 371 Date: Oct. 17, 2023

(51) Int. Cl. H04L 1/1825; H04L 1/1867

(52) U.S. Cl. CPC H04L 1/1825; H04L 1/1896

(57) ABSTRACT

This disclosure presents solutions for a communication system of a non-terrestrial network (NTN) node and a user equipment (UE) to determine, where the NTN node can determine one or more HARQ retransmission schemes for one or more LCHs used by the UE. The HARQ retransmission scheme can be mapped into one, two, or five bits of the DCI signal, depending on the mapping algorithm selected. In some example embodiments. LCHs can be grouped by using similar LCH prioritization or similar HARQ retransmission schemes. HARQ retransmission schemes can be mapped to the LCG. If there remains sufficient data space in the TBS/UL, other LCH can be included into the transmission even though the other LCH utilize different HARQ retransmission schemes. The UE can encode its HARQ transmission using the HARQ retransmission scheme indicated for the LCH the UE is utilizing.

### TECHNICAL FIELD

This application is directed, in general, to user equipment uplink data transmissions and, more specifically, to indicate retransmission schemes.

### BACKGROUND

In a communication system with user equipment (UE) and a communication node, where the communication node is a non-terrestrial network (NTN) node, there may be long communication delays due to the distance between the UE and the NTN node. 3GPP has defined a work item for Rel-17 on NTNs to study support for NTN nodes to provide operations in remote areas with low or no ground based cellular connectivity. The NTN can be deployed in a complementary manner to terrestrial deployments where the NTN connectivity can provide coverage beyond terrestrial deployments. HARQ enabling and disabling is one important function discussed in this work item. The benefit of disabling HARQ retransmissions for NTN is to enable the gNB to reuse an HARQ process ID before a full HARQ RTT has elapsed to avoid the HARQ stalling and reduce the transmission latency as well as enable peak throughput.

### SUMMARY

In one example embodiment, an apparatus is disclosed. The apparatus comprises (1) one or more processors, and (2) memory storing instructions and data that, when executed by the one or more processors, cause the apparatus to: (1) determine one or more hybrid automatic repeat request (HARQ) retransmission schemes to be utilized by a user equipment (UE), and indicate the one or more HARQ retransmission schemes to the UE.

In a second example embodiment, an apparatus is disclosed. The apparatus comprises (1) one or more processors, and (2) memory storing instructions and data that, when executed by the one or more processors, cause the apparatus to: (1) receive one or more HARQ retransmission schemes from a non-terrestrial network (NTN) node, and (2) perform a logical channel prioritization (LCP) procedure with the one or more HARQ retransmission schemes.

In a third example embodiment, a method is disclosed. The method comprises (1) determining one or more HARQ retransmission schemes to be utilized by a UE, and (2) indicating the one or more HARQ retransmission schemes to the UE.

In a fourth example embodiment, a method is disclosed. The method comprises (1) receiving one or more HARQ retransmission schemes from an NTN node, and (2) performing a LCP procedure with the one or more HARQ retransmission schemes.

In a fifth example embodiment, a system is disclosed. The system comprises (1) an NTN node, capable to transceive communications and to determine one or more HARQ retransmission schemes for one or more logical channels (LCHs), to encode the one or more HARQ retransmission schemes in a RRC signalling, and to transit the RRC signalling, and (2) a UE, capable to transceive communications with the NTN node utilizing the one or more LCHs and corresponding received HARQ retransmission schemes, wherein the UE encodes a HARQ transmission utilizing the received HARQ retransmission schemes indicated for one LCH of the one or more LCHs.

### BRIEF DESCRIPTION

Reference is now made to the following descriptions taken in conjunction with the accompanying drawings, in which:

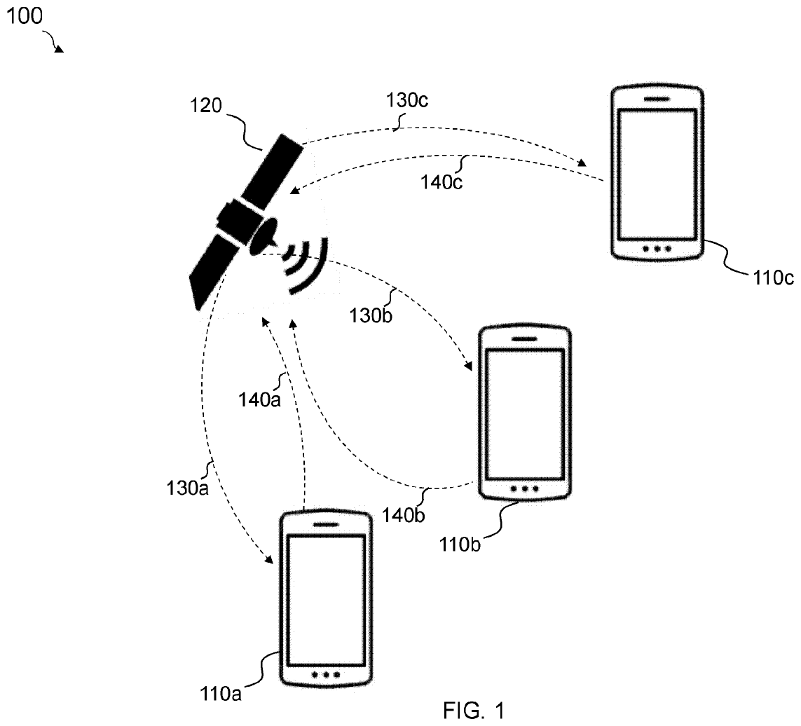

FIG. 1 is an illustration of a diagram of an example communication scenario with a non-terrestrial network (NTN) node and multiple user equipment (UEs);

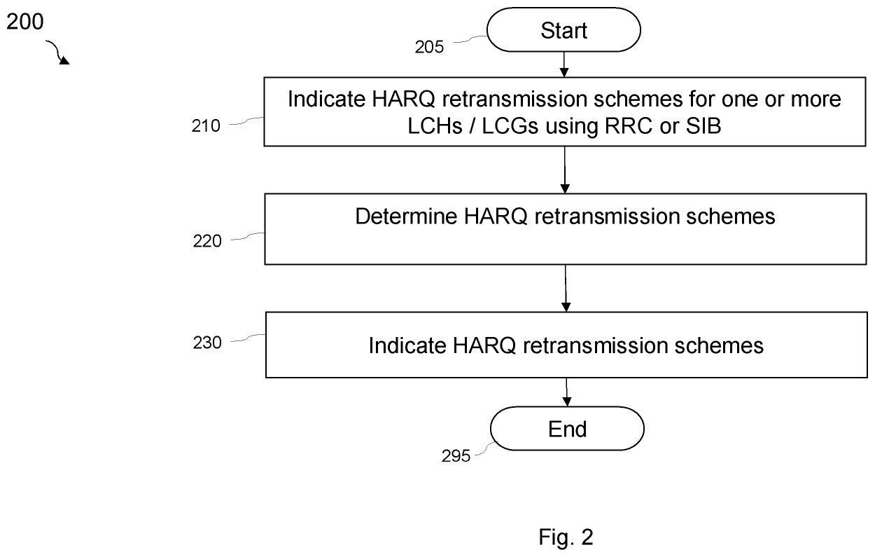

FIG. 2 is an illustration of a flow diagram of an example method to indicate a hybrid automatic repeat request (HARQ) retransmission scheme;

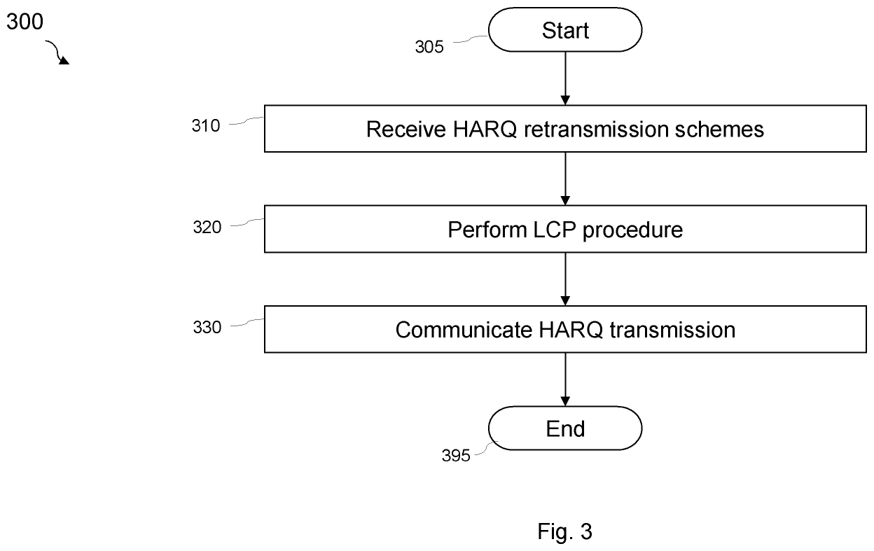

FIG. 3 is an illustration of a flow diagram of an example method to encode a HARQ transmission using a HARQ retransmission scheme;

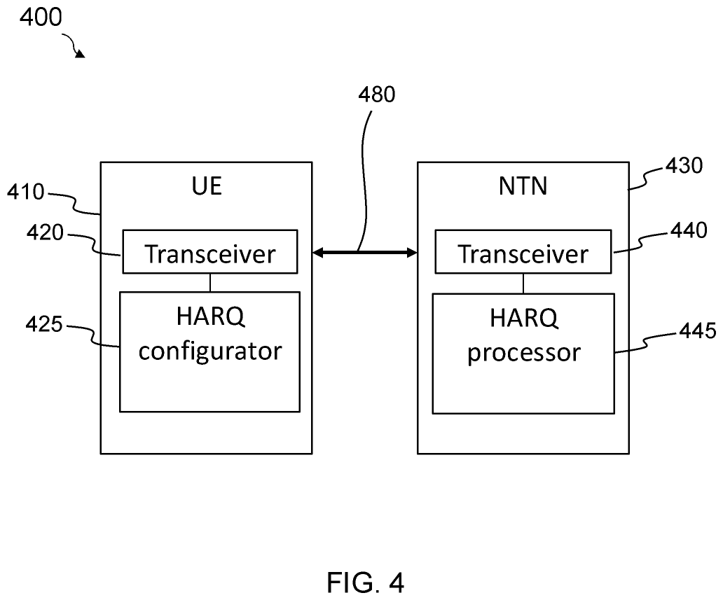

FIG. 4 is an illustration of a block diagram of an example communication system using a HARQ retransmission indicator; and

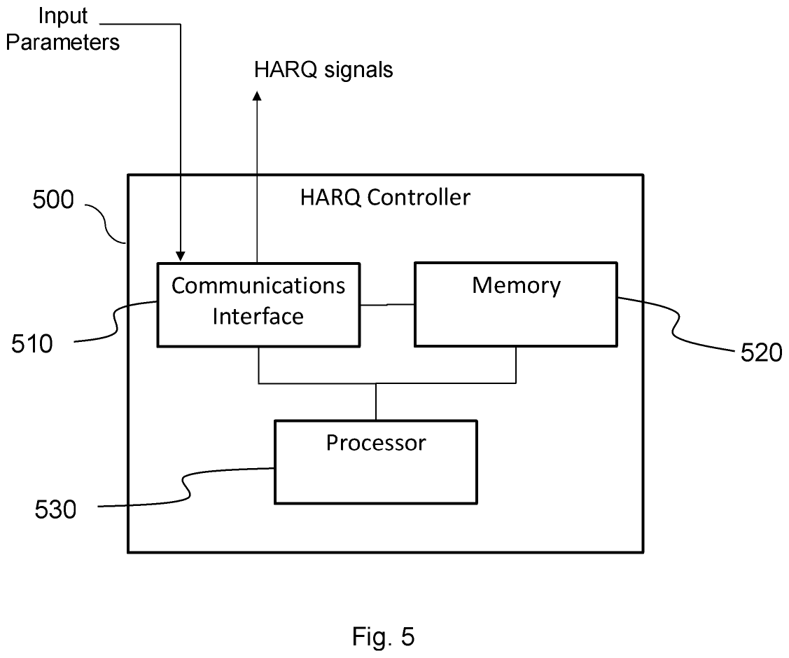

FIG. 5 is an illustration of a block diagram of an example of a HARQ controller according to the principles of the disclosure.

### DETAILED DESCRIPTION

In the 5G third-generation partnership project (3GPP) Release 17 proposed standard, there is a work item on non-terrestrial networks (NTNs) in (RP-201256). Hybrid automatic repeat request (HARQ) enabling and disabling is a function discussed in this work item. The benefit of disabling HARQ retransmissions for NTN is to enable an NTN node to reuse a HARQ process identification (ID) before a full HARQ round trip time (RTT) has elapsed to avoid the HARQ stalling and reduce transmission latency as well as improve the peak throughput.

UEs, such as mobile phones, tablets, laptops, and other 5G devices whether movable, mobile, or stationary, can establish a communication link with one or more network devices, i.e., the NTN nodes. For example, various NTN nodes can be a communication node, such as radio access network (RAN) such as a 5G base station (gNB), an evolved universal mobile telecommunications system (UMTS), terrestrial radio access (E-UTRA), an enhanced 4G eNodeB E-UTRA base station (eNB), e.g., an enhanced Node B, an enhanced gNB (en-gNB), or a next generation eNB (ng-eNB). The NTN node can be implemented using various non-terrestrial systems, for example, balloons, airplanes, satellites, and other non-terrestrial based systems. A UE is capable to transceive, e.g., transmit and receive, communications with one or more nodes of the NTN.

Considering the potential for long delays when communicating between a UE and an NTN node, where the propagation distances can be significantly larger than the propagation distances between the UE and a ground-based communication node, with limited number of HARQ process and waiting for a RTT for a HARQ signal may lead to delays in subsequent signalling and data transmissions as well as HARQ stalling. For example, in a case where the satellite is a regenerative geostationary earth orbit (GEO) satellite with an altitude of 35,786 kilometers (km), a distance between the GEO satellite and the UE at the nadir point is 35,786 km and a one-way propagation delay can be 119.286 milliseconds (ms). In the communication system using a low-earth orbit (LEO) satellite at 600 km altitude, the maximum delay can be 6,440 ms for a UE with a 10-degree elevation angle. HARQ stalling can result in a reduced throughput and data rate for packet transmission in NTN scenarios.

In previous 3GPP meetings, some agreements have been made. From a RAN2 perspective, for dynamic grant, one possibility for enabling/disabling a HARQ uplink (UL) retransmission at a UE transmitter is to reuse existing mechanisms, e.g., the NTN can send a UL grant with a new data indicator (NDI) not toggled/toggled while not waiting for a decoding result of a previous physical uplink shared channel (PUSCH) transmission. Other solutions for enabling/disabling HARQ UL retransmissions are not precluded. A logical channel (LCH) impact caused by disabling HARQ UL retransmission should be considered. For HARQ processes where the NTN node can send an UL grant without waiting for the decoding of a result of a previous PUSCH transmission, no new network scheduling restrictions should be introduced to schedule subsequent grants. This can be a network implementation.

It can be a network scheduling strategy to avoid an NTN-UE HARQ stalling state. The network can continuously schedule the UE using one or a combination of scheduling strategies, such as with HARQ retransmissions enabled or disabled, with blind retransmissions, or with HARQ retransmissions utilizing downlink (DL) HARQ feedback or a UL decoding result.

Logical channel prioritization (LCP) restrictions should be further considered for an UL HARQ process in NTN. For further study are scenarios where no further LCP restrictions are needed, if REL 16 LCP restrictions can be re-used, or if new LCP restrictions shall be defined for this purpose.

There is a proposal that one HARQ process can be scheduled with different retransmission schemes to support the scheduling flexibility. For example, one HARQ process can be scheduled with different retransmission schemes in different scheduling occasions. The different retransmission schemes can be, for example, scheduling the UE without HARQ retransmissions, scheduling the UE with blind retransmissions, scheduling the UE with HARQ retransmissions utilizing a UL decoding result, or other retransmission schemes.

To support one HARQ process to be scheduled with different retransmission schemes in different scheduling occasions, the solution for DL that HARQ process can be configured with HARQ feedback enabled or disabled using radio resource control (RRC) signalling. The retransmission scheme is indicated to the UE utilizing a HARQ process ID in a downlink control information (DCI) and cannot be utilized in UL. A new mechanism to indicate the HARQ retransmission scheme is needed for UL in NTN. To facilitate LCP in the case one HARQ process is scheduled with different retransmission schemes in different scheduling occasions, a new mechanism to indicate the HARQ retransmission scheme for UL in NTN is disclosed.

In this disclosure, solutions are presented to improve the ability to indicate multiple retransmission schemes that can be supported for one HARQ process. The solutions can provide scheduling flexibility on utilizing different retransmission schemes.

In some example embodiments, each service channel and LCH can be configured with one or more HARQ retransmission schemes by the NTN node through RRC signalling, such as a RRCReconfiguration signal or a system information block. In some example embodiments, the NTN node can perform dynamic scheduling to determine the different HARQ retransmission schemes and can indicate the selected HARQ retransmission schemes in a DCI signal. The Log₂N bits in the DCI message can indicate the HARQ retransmission schemes when N kinds of HARQ retransmission schemes are supported.

In some example embodiments, there can be various kinds of HARQ retransmission schemes, for example, without HARQ retransmissions, blind retransmissions, HARQ retransmissions utilizing DL HARQ feedback, HARQ retransmissions utilizing a UL decoding result, and other kinds of HARQ retransmission schemes. Two bits in a DCI signal can indicate the retransmission schemes. For example, “00” can indicate without HARQ retransmissions, “01” can indicate a blind retransmission, “10” can indicate a HARQ retransmission based on UL decoding result.

In some example embodiments, when blind retransmission is divided into continuous blind retransmission and retransmission scattered in a time domain, “01” can indicate the continuous blind retransmission and “11” can indicate the retransmission scattered in a time domain. Other encoding schemes can be utilized as well.

In some example embodiments, in LCP, the UE can include the data from a LCH where the LCH has a configured HARQ retransmission scheme that is the same as the HARQ retransmission scheme indicated in the UL grant when multiplexing. In some example embodiments, if there is remaining space in the transport block size (TBS)/UL grant for more data, the data from a second LCH can be included, where the second LCH has a configured HARQ retransmission scheme that is different from the encoded, e.g., indicted or mapping algorithm, HARQ retransmission scheme. In some example embodiments, the HARQ retransmission scheme can be directly indicated in the DCI. In some example embodiments, the HARQ retransmission scheme can be derived by a mapping algorithm.

In some example embodiments, each service channel and LCH can be configured with one HARQ retransmission scheme by the NTN node through RRC signalling. The NTN node can perform the dynamic scheduling as well as determine the different HARQ retransmission schemes considering factors such as quality of service (QOS) parameters, including the data rate, the latency, reliability, resource efficiency, and other parameters. The NTN node can select one LCH whose HARQ retransmission scheme is the same as the determined HARQ retransmission scheme and indicate the LCH ID of the selected LCH in the DCI. The UE can receive the HARQ retransmission scheme utilizing the mapping between the indicated LCH ID and the HARQ retransmission schemes. The mapping can utilize five bits on the LCH ID in DCI to indicate the selected LCH.

In some example embodiments the selected LCH can be indicated with the selected order of the LCH in the configured LCHs. For example, if M LCHs are configured, and the LCHs are arranged in the ascending order of LCH ID, then the Log₂M bits in DCI can indicate the LCH order of the selected LCH ID, e.g., the index M for the HARQ retransmission scheme. For example, four LCHs (LCH1, LCH2, LCH3 and LCH4) can be configured. The four LCHs can be arranged in the ascending order of the LCH ID. Two bits in the DCI signal can indicate the LCH order of the selected LCH ID, e.g., “00” indicates LCH1, “01” indicates LCH2, “10” indicates LCH3 and “11” indicates LCH4.

Each LCH can be configured with one HARQ retransmission scheme by the NTN node through RRC signalling or a system information block. For example, LCH1 can be configured with ‘without HARQ retransmissions’, LCH2 and LCH3 can be configured with blind retransmission, and LCH4 can be configured with HARQ retransmission based on UL decoding result. The NTN node can perform the dynamic scheduling as well as to determine the different HARQ retransmission schemes. The NTN node can select one LCH whose HARQ retransmission scheme is the same as the determined HARQ retransmission scheme. In this example, LCH2 can be selected and the NTN node can indicate the LCH order of LCH2, e.g., “01”, in the DCI.

In some example embodiments, the UE can receive the HARQ retransmission scheme, e.g., LCH2 utilizing the mapping between the indicated LCH ID order and the HARQ retransmission scheme. In LCP, the UE can include the data from the LCHs whose configured retransmission scheme is the same with the retransmission scheme of the indicated LCH in the UL grant when multiplexing, in this example, LCH2 and LCH3. If there is remaining room in the TBS/UL grant for more data, the data from the other LCHs, e.g., LCH1 and LCH4, can be included.

In some example embodiments, the service channels and LCHs can be grouped, utilizing the QoS parameter, where each logical channel group (LCG) can be configured with one HARQ retransmission scheme. The NTN node can select one LCH group, from a set of LCH, where the LCH group HARQ retransmission scheme is the same as the determined HARQ retransmission scheme and can indicate the LCH group ID of the selected LCH group in the DCI. The LCG for the buffer report can be reused since the NTN node can get the buffer status of each LCG and perform scheduling with the granularity of the LCG.

For example, four LCHs (LCH1, LCH2, LCH3 and LCH4) can be configured. LCH1 and LCH2 can be grouped into one LCG, e.g., LCG1, which have similar QoS parameters and can be configured with one HARQ retransmission scheme. LCH3 and LCH4 can be grouped into a second LCG, e.g., LCG2, which have similar QoS parameters and can be configured with a second HARQ retransmission scheme. The NTN node can determine the HARQ retransmission scheme and select a LCG where the LCG has a HARQ retransmission scheme that is the same as the determined HARQ retransmission scheme. In this example, one bit in DCI can be used to indicate the LCG ID of the selected LCG in the DCI, e.g., “0” can indicate LCG1 and “1” can indicate LCG2.

In some example embodiments, the group criteria for the LCHs can be the same with LCG for a buffer status report (BSR), since the NTN node can know what data the UE has from the BSRs and scheduling reports (SRs). The NTN node can estimate the UE buffer content and schedule as well as determine the HARQ retransmission scheme accordingly. The granularity of the scheduling and HARQ retransmission scheme can utilize the BSR and the LCG for the HARQ retransmission scheme is the same as the LCG for the BSR.

In some example embodiments, in LCP, the UE can include the data from the LCGs where the LCGs have a configured HARQ retransmission scheme that is the same as the HARQ retransmission scheme of the indicated LCH group in the UL grant when multiplexing. If there is remaining room in the TBS/UL grant for more data, the data from other LCGs can be included.

In some example embodiments, the HARQ processes can be divided into two groups. One group can be for HARQ disabled retransmissions, and the second group can be for other HARQ retransmission schemes, e.g., such as the HARQ retransmission based on UL decoding result or blind retransmission. Each kind of service channel and LCH can be configured with the HARQ group or scheme of the HARQ group by the NTN node through RRC signalling.

The NTN node can perform the dynamic scheduling as well as determine the different HARQ retransmission schemes. In some example embodiments, when the HARQ retransmission scheme is HARQ disabled, then the NTN node can use the HARQ process ID in DCI to indicate the HARQ retransmission scheme as a default. In some example embodiments, when the HARQ retransmission scheme is a HARQ retransmission based on UL decoding result or blind retransmission, the HARQ process ID and one additional bit in DCI can be used to indicate the HARQ retransmission scheme, e.g., “0” can indicate a HARQ retransmission based on UL decoding result and “1” can indicate a blind retransmission.

For example, when 32 HARQ processes are supported, and 2 HARQ processes, e.g., HARQ process #0 and HARQ process #1, can be configured with HARQ disabled, and the remaining HARQ processes, e.g., HARQ process #2 to HARQ process #31, can be configured with the HARQ enabled and blind retransmission.

In some example embodiments, in LCP, the UE can include the data from the LCHs where the LCH configured HARQ retransmission scheme is the same as derived in the UL grant when multiplexing. If there is remaining room in the TBS/UL grant for more data, the data from other LCH can be included.

An example, for demonstration purposes, of the messaging changes to the 3GPP standard are shown in Table 1. Other messaging changes and different messaging changes can be utilized to implement this disclosure; Table 1 is for example.

TABLE 1
Example messaging to support an
indication of HARQ retransmission

| Message | Change |
|---|---|
| Message: RRC, | Add field for HARQ retransmission scheme |
| SIB, DCI | (Allow NTN to specify HARQ retransmission. Field can |
| | be one, two, five, or other bit lengths to hold the HARQ |
| | retransmission encoding.) |
| | Configure the retransmission scheme to LCH/LCG. |
| | Configure the LCG for LCHs. |
| | LCP procedure supporting multiple retransmission |
| | schemes. |

Turning now to the figures, FIG. 1 is an illustration of a diagram of an example communication scenario 100 with a NTN node and multiple UEs. Communication scenario 100 is a demonstration of one type of environment for this disclosure. The environment for communication scenario 100 includes a UE 110a, a UE 110b, a UE 110c (collectively, UEs 110), and a NTN node 120. There can be fewer or additional UEs in UEs 110. NTN node 120 can be various types of communication nodes, such as a gNB, and be implemented on one of various types of vehicles, such as a balloon, an airplane, a glider, a satellite, or other vehicle types.

An example set of DL and UL signals are shown in communication scenario 100. At a receipt of a DCI signal, UE 110a can receive HARQ retransmission schemes from NTN node 120 using DL 130a. The HARQ retransmission schemes can indicate a preferred scheme, and whether additional LCH can be added if there is additional space in the TBS/UL. Likewise, UE 110b can receive its HARQ retransmission schemes through DL 130b and UE 110c can receive its HARQ retransmission schemes through DL 130c, (collectively, DLs 130). The HARQ retransmission schemes received by each UE in UEs 110 do not need to be the same.

A UL 140a can be used to send the encoded HARQ transmission to the NTN node, utilizing the selected HARQ retransmission scheme received from the NTN node. A UL 140b can be used to send the HARQ transmission for UE 110b, and a UL 140c can be used to send the HARQ transmission for UE 110c (collectively, ULs 140).

FIG. 2 is an illustration of a flow diagram of an example method 200 to indicate a HARQ retransmission. Method 200 can be performed by NTN node, or partially by an NTN node. In some example embodiments, HARQ retransmission schemes can be received by the UE from the NTN node. Method 200 can be performed, for example, wholly or in part, by communication scenario 100 of FIG. 1, by communication system 400 of FIG. 4, or by HARQ controller 500 of FIG. 5.

Method 200 begins at a step 205 and proceeds to a step 210. In step 210, communicate the one or more HARQ retransmission schemes for one kind of service or one kind of LCH to the UE using at least one of a system information block, or a RRC signalling. The HARQ retransmission schemes can be one of without HARQ retransmissions, blind retransmissions, or HARQ retransmissions utilizing a UL decoding result. LCHs can be grouped together to form one or more LCGs. Each LCG can be indicated with a HARQ retransmission scheme.

In a step 220, a determination is made of the types of HARQ retransmission schemes for a UE, wherein the one or more HARQ retransmission schemes are determined using scheduling, wherein the scheduling is one of a dynamic scheduling or a configured grant.

In a step 230, HARQ retransmission schemes can be indicated to the UE using an encoding of the HARQ retransmission schemes to the LCH or LCG, for example, using a mapping. The encoding can utilize one, two, or five bits of the DCI signal. An order or ID of the LCH or the LCG can be utilized as a mapping key to the appropriate HARQ retransmission scheme. There can be one or more HARQ retransmission schemes for each LHC or LCG, e.g., each LCH can have a set of the one or more HARQ retransmission schemes. In a step 295, method 200 ends.

FIG. 3 is an illustration of a flow diagram of an example method 300 to utilize a HARQ retransmission scheme. Method 300 can be performed by a UE or partially by a UE. In some example embodiments, HARQ retransmission schemes can be received by the UE from the NTN node. Method 300 can be performed, for example, wholly or in part, by communication scenario 100 of FIG. 1, by communication system 400 of FIG. 4, or by HARQ controller 500 of FIG. 5.

Method 300 begins at a step 305 and proceeds to a step 310. In step 310, a UE can receive HARQ retransmission schemes from a NTN node. The HARQ retransmission schemes can be mapped to a LCH or a LCG.

In a step 320, the UE can perform an LCP procedure utilizing an encoding of the HARQ transmission utilizing the HARQ retransmission scheme that is indicated for the LCH or LCG that is being sent at that time interval. In a step 330, the UE can communicate its HARQ transmission as encoded. Method 300 ends at a step 395.

FIG. 4 is an illustration of a block diagram of an example communication system 400 using an HARQ retransmission indicator. Communication system 400 is an example system and could have additional communication nodes and additional UEs. Communication system 400 can implement the disclosed solutions, such as method 200 of FIG. 2, method 300 of FIG. 3, and implement the HARQ controller 500 of FIG. 5. Communication system 400 has a UE 410 and an NTN node 430.

UE 410 has a transceiver 420 capable of receiving communication signals and transmitting communication signals with NTN node 430 using a signal connection 480, for example, receiving one or more HARQ retransmission schemes from NTN node 430. Signal connection 480 can be used to transmit a HARQ signals, scheduling information (SR), BSR, and other data to NTN node 430. UE 410 has a UE HARQ configurator 425, which can determine how UE 410 utilizes the received HARQ retransmission scheme and can build the appropriate encoded HARQ retransmission, for example, the utilizing the algorithms described in method 200 of FIG. 2 or method 300 of FIG. 3.

NTN node 430 has a transceiver 440 capable of receiving communication signals and transmitting communication signals with UE 410 using signal connection 480. Communication node 430 has a HARQ processor 445 that is capable of analyzing the received UE parameters, such as SR and BSR data, such as received from UE 410. HARQ processor 445 is capable of determining HARQ retransmission schemes to be utilized by UE 410, such as without HARQ retransmissions, blind retransmissions, HARQ retransmissions utilizing DL HARQ feedback, HARQ retransmissions utilizing a UL decoding result. NTN node 430 can communicate the HARQ retransmission schemes to UE 410 using, for example, a system information signal, an RRC signal, a DCI, or other signals.

The elements of UE 410 and NTN node 430 are shown as a functional view, where the implementation can be by software, hardware, or a combination thereof. In some aspects, the functions shown can be combined with other functions of the respective UE 410 or NTN node 430.

FIG. 5 is an illustration of a block diagram of an example of a HARQ controller 500 according to the principles of the disclosure. HARQ controller 500 can be stored on a single computer or on multiple computers. The various components of HARQ controller 500 can communicate via wireless or wired conventional connections. A portion or a whole of HARQ controller 500 can be located as part of a UE and other portions of HARQ controller 500 can be located as part of a NTN node communicating with the NTN node. HARQ controller 500 can be virtual or partially virtual while hosted on another system or process.

HARQ controller 500 can be configured to perform the various functions disclosed herein including receiving HARQ retransmission schemes or determining a set of HARQ retransmission schemes to send to a UE. The various functions performed can be an execution of the methods and processes described herein, such as method 200 of FIG. 2 or method 300 of FIG. 3. HARQ controller 500 can implement communication system 400 of FIG. 4. HARQ controller 500 includes a communications interface 510, a memory 520, and a processor 530.

Communications interface 510 is configured to transmit and receive data. For example, communications interface 510 can receive the HARQ retransmission schemes from an NTN node. Communications interface 510 can transmit the HARQ transmissions to an NTN node. In other example embodiments, communication interface 510 can transmit the HARQ retransmission schemes allowed by the NTN node. Communications interface 510 can communicate via communication systems used in the industry. For example, wireless or wired protocols can be used. Communication interface 510 is capable of performing the operations as described for transceiver 420 of FIG. 4 or transceiver 440 of FIG. 4.

Memory 520 can be configured to store a series of operating instructions and data, e.g., storing instructions and data, that direct the operation of processor 530 when initiated, including the code representing the algorithms for encoding the HARQ retransmission scheme or utilizing the HARQ retransmission scheme to encode a HARQ transmission. Memory 520 is a non-transitory computer readable medium. Multiple types of memory can be used for data storage and memory 520 can be distributed.

Processor 530 can be configured to determine the appropriate HARQ retransmission scheme for a UE or utilize a received HARQ transmission scheme to encode a HARQ transmission. Processor 530 can be configured to direct the operation of the HARQ controller 500. Processor 530 includes the logic to communicate with communications interface 510 and memory 520, and perform the functions described herein to determine the HARQ retransmission scheme. Processor 530 is capable of performing or directing the operations as described by HARQ processor 445 or HARQ processor of FIG. 4.

A portion of the above-described apparatus, systems or methods may be embodied in or performed by various analog or digital data processors, wherein the processors are programmed or store executable programs of sequences of software instructions to perform one or more of the steps of the methods. A processor may be, for example, a programmable logic device such as a programmable array logic (PAL), a generic array logic (GAL), a field programmable gate arrays (FPGA), or another type of computer processing device (CPD). The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple, or all of the steps of one or more of the above-described methods, or functions, systems or apparatuses described herein.

Portions of disclosed examples or embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Examples of program code include machine code, such as produced by a compiler, and files containing higher level code that may be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Those skilled in the art to which this application relates will appreciate that other and further additions, deletions, substitutions, and modifications may be made to the described embodiments. It is also to be understood that the terminology used herein is for the purpose of describing particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

Each of the aspects as described in the SUMMARY section can have one or more of the following additional elements in combination. Element 1: wherein the one or more HARQ retransmission schemes are determined using a scheduling, wherein the scheduling is one of a dynamic scheduling or a configured grant. Element 2: wherein the one or more HARQ retransmission schemes are each one of without HARQ retransmissions, blind retransmissions, or HARQ retransmissions utilizing an UL decoding result. Element 3: wherein Log₂M bits in a DCI indicates an index M HARQ retransmission scheme of the one or more HARQ retransmission schemes. Element 4: wherein the Log₂M bits is represented by two bits in the DCI. Element 5: communicate the one or more HARQ retransmission schemes for one kind of service or one kind of LCH to the UE using at least one of a system information block, or a RRC signalling. Element 6: wherein one LCH is selected where a LCH HARQ retransmission scheme of the one LCH is the same as a determined HARQ retransmission scheme, the LCH HARQ retransmission scheme is part of the one or more HARQ retransmission schemes, and the indicate the one or more HARQ retransmission schemes utilizes a LCH ID for the one LCH in a DCI. Element 7: wherein configured LCHs are arranged in a selected order, one LCH is selected from the configured LCHs, where a LCH HARQ retransmission scheme of the one LCH is the same as a determined HARQ retransmission scheme, the LCH HARQ retransmission scheme is part of the one or more HARQ retransmission schemes, and the indicate the one or more HARQ retransmission schemes utilizes an index of the one LCH in a DCI. Element 8: wherein a LCG is determined from available LCHs utilizing a QoS parameter, and the LCG is configured with a HARQ retransmission scheme of the one or more HARQ retransmission schemes using a RRC signalling or a system information block. Element 9: wherein more than one LCG is determined, a selected LCG of the more than one LCG is selected where a HARQ retransmission scheme of the selected LCG is the same as a determined HARQ retransmission scheme and the indicate the one or more HARQ retransmission schemes utilizes an ID of the selected LCG in a DCI. Element 10: wherein the LCG group is further determined as the LCG for a BSR. Element 11: wherein HARQ processes are grouped into one of a first HARQ group or a second HARQ group, where the first HARQ group utilize a first HARQ retransmission scheme and the second HARQ group utilizes a set of HARQ retransmission schemes, and the set of HARQ retransmission schemes includes at least two HARQ retransmission schemes. Element 12: communicate the first HARQ retransmission scheme and the set of HARQ retransmission schemes as the one or more HARQ retransmission schemes, and inform the UE that the first HARQ group indicates a HARQ retransmission scheme for each respective HARQ process in the first HARQ group and the second HARQ group indicates more than one HARQ retransmission scheme for each respective HARQ process in the second HARQ group, using at least one of a system information block or a RRC signalling. Element 13: wherein the first HARQ retransmission scheme utilizes a without HARQ retransmissions, and the set of HARQ retransmission schemes includes a HARQ retransmission based on UL decoding result or a blind retransmission. Element 14: wherein the first HARQ retransmission scheme utilizes a first HARQ process ID to indicate the first HARQ retransmission scheme, and the set of HARQ retransmission schemes utilizes a second HARQ process ID and one or more bits in a DCI signal to indicate a second HARQ retransmission scheme from the set of HARQ retransmission schemes. Element 15: wherein the set of HARQ retransmission schemes includes a HARQ retransmission based on UL decoding result and a blind retransmission, and the set of HARQ retransmission schemes utilizes a second HARQ process ID and one bit in a DCI signal to indicate one of the HARQ retransmission based on UL decoding result or the blind retransmission. Element 16: wherein the apparatus is an NTN node. Element 17: wherein the NTN is one of a gNB, an UMTS, E-UTRA, an eNB, an en-gNB, or a ng-eNB. Element 18: wherein the one or more HARQ retransmission schemes for one kind of service or one kind of LCH are received using at least one of a system information block or a RRC signalling. Element 19: wherein the one or more HARQ retransmission schemes are indicated by a HARQ retransmission scheme in a DCI. Element 20: wherein, when multiplexing, the LCP procedure utilizes a LCH from one or more LCHs, where transmission data from the LCH utilizes a HARQ retransmission scheme that is the same as the HARQ retransmission scheme indicated in the DCI. Element 21: wherein the LCP procedure utilizes data from an LCH of one or more LCHs where a HARQ retransmission scheme of the LCH is different than a HARQ retransmission scheme derived from the DCI when space remains in a TBS UL. Element 22: wherein the one or more HARQ retransmission schemes are indicated utilizing a mapping of an indicated LCH ID to a HARQ retransmission in a DCI. Element 23: wherein Log₂M bits in a DCI indicates an index M HARQ retransmission scheme of the one or more HARQ retransmission schemes. Element 24: wherein the Log₂M bits is represented by two bits in the DCI. Element 25: wherein the one or more HARQ retransmission schemes for a LCG are received utilizing a RRC signalling or a system information block, where one or more LCHs are part of the LCG. Element 26: wherein the one or more HARQ retransmission schemes are indicated utilizing a mapping of IDs of one or more LCGs to a HARQ retransmission in a DCI, where one or more of the one or more LCHs are part of the one or more LCGs. Element 27: wherein, when multiplexing, the LCP procedure utilizes a LCG from the one or more LCHs, where data from the LCG utilizes a HARQ retransmission scheme that is the same as the HARQ retransmission scheme indicated in the DCI. Element 28: wherein the LCP procedure utilizes data from an LCG of the one or more LCHs where a HARQ retransmission scheme of the LCG is different than a HARQ retransmission scheme derived from the DCI when space remains in a TBS UL. Element 29: wherein HARQ processes are grouped into one of a first HARQ group or a second HARQ group, where the first HARQ group utilizes a first HARQ retransmission scheme and the second HARQ group utilizes a set of HARQ retransmission schemes, the set of HARQ retransmission schemes includes at least two HARQ retransmission schemes, and the first HARQ retransmission scheme and the set of HARQ retransmission schemes are part of the one or more HARQ retransmission schemes. Element 30: wherein the one or more HARQ retransmission schemes for the first HARQ group and the second HARQ group are received utilizing a system information block or a RRC signalling. Element 31: wherein the first HARQ retransmission scheme utilizes a without HARQ retransmission scheme, and the set of HARQ retransmission schemes includes a HARQ retransmission based on UL decoding result or a blind retransmission. Element 32: wherein the first HARQ retransmission scheme utilizes a first HARQ process ID to indicate a first HARQ retransmission scheme, and the set of HARQ retransmission schemes utilizes a second HARQ process ID and one or more bits in a DCI signal to indicate a second HARQ retransmission scheme in the set of HARQ retransmission schemes. Element 33: wherein the set of HARQ retransmission schemes includes a HARQ retransmission based on UL decoding result and a blind retransmission, and the set of HARQ retransmission schemes utilizes a second HARQ process ID and one bit in a DCI signal to indicate one of the HARQ retransmission based on UL decoding result or the blind retransmission.

1. An apparatus, comprising:
one or more processors; and
memory storing instructions and data that, when executed by the one or more processors, cause the apparatus to:
determine one or more hybrid automatic repeat request (HARQ) retransmission schemes to be utilized by a user equipment (UE); and
indicate the one or more HARQ retransmission schemes to the UE.

2. The apparatus as recited in claim 1, wherein the one or more HARQ retransmission schemes are determined using a scheduling, wherein the scheduling is one of a dynamic scheduling or a configured grant.

3. The apparatus as recited in claim 1, wherein the one or more HARQ retransmission schemes are each one of without HARQ retransmissions, blind retransmissions, or HARQ retransmissions utilizing an uplink (UL) decoding result.

4.-17. (canceled)

18. An apparatus, comprising:
one or more processors; and
memory storing instructions and data that, when executed by the one or more processors, cause the apparatus to:
receive one or more hybrid automatic repeat request (HARQ) retransmission schemes from a non-terrestrial network (NTN) node; and
perform a logical channel prioritization (LCP) procedure with the one or more HARQ retransmission schemes.

19. The apparatus as recited in claim 18, wherein the one or more HARQ retransmission schemes for one kind of service or one kind of logical channel (LCH) are received using at least one of a system information block or a radio resource control (RRC) signalling.

20. The apparatus as recited in claim 18, wherein the one or more HARQ retransmission schemes are received utilizing a HARQ retransmission scheme in a downlink control information (DCI).

21. The apparatus as recited in claim 20, wherein, when multiplexing, the LCP procedure utilizes an LCH from one or more LCHs, where transmission data from the LCH utilizes a HARQ retransmission scheme that is the same as the HARQ retransmission scheme indicated in the DCI.

22. The apparatus as recited in claim 20, wherein the LCP procedure utilizes data from an LCH of one or more LCHs where a HARQ retransmission scheme of the LCH is different than a HARQ retransmission scheme derived from the DCI when space remains in an uplink (UL) transport block size (TBS).

23. The apparatus as recited in claim 18, wherein the one or more HARQ retransmission schemes are indicated utilizing a mapping of an indicated LCH identification (ID) to a HARQ retransmission in a DCI.

24. The apparatus as recited in claim 18, wherein Log2M bits in a DCI indicates an index M HARQ retransmission scheme of the one or more HARQ retransmission schemes.

25. The apparatus as recited in claim 24, wherein the Log2M bits is represented by two bits in the DCI.

26. The apparatus as recited in claim 18, wherein the one or more HARQ retransmission schemes for a logical channel group (LCG) are received utilizing a RRC signalling or a system information block, where one or more LCHs are part of the LCG.

27. The apparatus as recited in claim 26, wherein the one or more HARQ retransmission schemes are received utilizing a mapping of IDs of one or more LCGs to a HARQ retransmission in a DCI, where one or more of the one or more LCHs are part of the one or more LCGs.

28. The apparatus as recited in claim 26, wherein, when multiplexing, the LCP procedure utilizes a logical channel group (LCG) from the one or more LCHs, where data from the LCG utilizes a HARQ retransmission scheme that is the same as the HARQ retransmission scheme indicated in the DCI.

29. The apparatus as recited in claim 26, wherein the LCP procedure utilizes data from an LCG of the one or more LCHs where a HARQ retransmission scheme of the LCG is different than a HARQ retransmission scheme derived from the DCI when space remains in an uplink (UL) transport block size (TBS).

30. The apparatus as recited in claim 18, wherein HARQ processes are grouped into one of a first HARQ group or a second HARQ group, where the first HARQ group utilizes a first HARQ retransmission scheme and the second HARQ group utilizes a set of HARQ retransmission schemes, the set of HARQ retransmission schemes includes at least two HARQ retransmission schemes, and the first HARQ retransmission scheme and the set of HARQ retransmission schemes are part of the one or more HARQ retransmission schemes.

31. The apparatus as recited in claim 30, wherein the one or more HARQ retransmission schemes for the first HARQ group and the second HARQ group are received utilizing a system information block or a RRC signalling.

32. (canceled)

33. The apparatus as recited in claim 30, wherein the first HARQ retransmission scheme utilizes a first HARQ process ID to indicate a first HARQ retransmission scheme, and the set of HARQ retransmission schemes utilizes a second HARQ process ID and one or more bits in a DCI signal to indicate a second HARQ retransmission scheme in the set of HARQ retransmission schemes.

34. The apparatus as recited in claim 30, wherein the set of HARQ retransmission schemes includes a HARQ retransmission based on UL decoding result and a blind retransmission, and the set of HARQ retransmission schemes utilizes a second HARQ process ID and one bit in a DCI signal to indicate one of the HARQ retransmission based on UL decoding result or the blind retransmission.

35.-50. (canceled)

51. A method, comprising:
receiving one or more hybrid automatic repeat request (HARQ) retransmission schemes from a non-terrestrial network (NTN) node; and
performing a logical channel prioritization (LCP) procedure with the one or more HARQ retransmission schemes.

52.-69. (canceled)
